(19) United States
(12) Patent Application Publication
(10) Pub. No.: US 2026/0229029 A1
(43) Pub. Date: Aug. 6, 2026

(54) SURFEL REPROJECTION OF SEMANTIC DATA FOR ACCELERATED AUGMENTED REALITY PERCEPTION

(71) Applicant: GOOGLE LLC, Mountain View, CA (US)

(72) Inventors: Eric Lee Turner, Somerville, MA (US); Pratibha Tripathi, Sunnyvale, CA (US); Keisuke Tateno, Zurich (CH); Stephanie Renee Debats, Palo Alto, CA (US); Adarsh Prakash Murthy Kowdle, San Francisco, CA (US)

(21) Appl. No.: 19/150,387

(22) PCT Filed: Feb. 15, 2023
(86) PCT No.: PCT/US2023/062647

§ 371 Date: Jul. 23, 2025

(51) Int. Cl. G06V 20/20; G06V 10/44; G06V 10/764; G06V 10/776; G06V 20/40; G06V 20/70

(52) U.S. Cl. CPC G06V 20/20; G06V 10/44; G06V 10/764; G06V 10/776; G06V 20/40; G06V 20/70

(57) ABSTRACT

Techniques include storing semantic information in data structures that are updated at a rate less than a nominal frame rate. For example, a semantic model is applied to a first camera image frame in a sequence of frames to produce semantic data for each pixel in the frame. In addition, a first edge image is derived from the first camera image frame to define boundaries for the semantic labels. A first semantic image may be derived from the semantic data and the first edge image. The semantic data is then stored in the data structures. For a second camera image frame of the sequence, a second edge image is derived but the semantic data is exported from the data structures to the second edge image to produce a second semantic image without generating new semantic data.

### TECHNICAL FIELD

This description relates in general to semantic image segmentation for sequences of image frames in, e.g., a video.

### SUMMARY

The improvement discussed herein is directed to a system and methods for generating semantic images of a video, or a sequence of camera image frames. Semantic images can be useful in, e.g., augmented reality (AR) applications, for example in identifying regions of a scene in which to place a virtual object (e.g., an arrow in a navigation application should be placed on a road and not in a tree). The improvement involves creating a first semantic image from a first camera frame of a sequence of camera image frames and storing the semantic information derived from the first semantic image in a data structure. The improvement then involves using the stored semantic information to generate a second semantic image from a second camera image frame of the sequence of camera image frames, the second camera image frame being after the first camera image frame in the sequence. Through this process, a semantic image can be constructed at a high frame rate based on stored semantic information and a camera image frame from a sequence.

In a general aspect, a method includes generating a first semantic image for a first image frame of a sequence of image frames by generating a respective semantic classification for each pixel of a plurality of pixels of the first image frame. The method also includes storing the respective semantic classification for at least a subset of the plurality of pixels of the first image frame in a set of data structures. The method further includes deriving a second semantic image for a second image frame of the sequence of image frames based on the respective semantic classification stored in the set of data structures.

In another general aspect, a computer program product comprising a nontransitory storage medium, the computer program product including code that, when executed by processing circuitry, causes the processing circuitry to perform a method. The method includes generating a first semantic image for a first image frame of a sequence of image frames by generating a respective semantic classification for each pixel of a plurality of pixels of the first image frame. The method also includes storing the respective semantic classification for at least a subset of the plurality of pixels of the first image frame in a set of data structures. The method further includes deriving a second semantic image for a second image frame of the sequence of image frames based on the respective semantic classification stored in the set of data structures.

In another general aspect, an apparatus comprises memory and processing circuitry coupled to the memory. The processing circuitry is configured to generate a first semantic image for a first image frame of a sequence of image frames by generating a respective semantic classification for each pixel of a plurality of pixels of the first image frame. The processing circuitry is also configured to store the respective semantic classification for at least a subset of the plurality of pixels of the first image frame in a set of data structures. The processing circuitry is further configured to derive a second semantic image for a second image frame of the sequence of image frames, based on the respective semantic classification stored in the set of data structures.

The details of one or more implementations are set forth in the accompanying drawings and the description below. Other features will be apparent from the description and drawings, and from the claims.

### BRIEF DESCRIPTION OF THE DRAWINGS

FIG. 1A illustrates an example three-dimensional scene in a camera image frame of a sequence, in accordance with implementations described herein.

FIG. 1B illustrates an example semantic image segmentation of the three-dimensional scene in FIG. 1A, in accordance with implementations described herein.

FIG. 1C illustrates an example three-dimensional scene in a subsequent camera image frame of the sequence, in accordance with implementations described herein.

FIG. 2A illustrates an example three-dimensional scene in a camera frame, in accordance with implementations described herein.

FIG. 2B illustrates an example surfel representation of the three-dimensional scene in FIG. 2A, in accordance with implementations described herein.

FIG. 3A is a flow chart illustrating an example high-level process of generating a sequence of semantic images from a sequence of camera image frames at the same frame rate, in accordance with implementations described herein.

FIG. 3B is a flow chart illustrating an example process of generating dense semantic images at a full framerate using surfel reprojection of the semantic data.

FIG. 4 is a diagram illustrating an example electronic environment for generating dense semantic images at a full framerate using surfel reprojection of the semantic data.

FIG. 5 is a flow chart illustrating a method of generating dense semantic images at a full framerate.

### DETAILED DESCRIPTION

Some image systems such as mapping systems assign semantic information in an image as a way to identify regions of an image in a way humans may do. For example, an image of a car parked in a street may have segments labelled semantically as follows: car, street, sidewalk, sky, grass, tree, building, person. The process of applying semantic labels to an image is known as semantic image segmentation. Semantic image segmentation may be important to unlocking a wide variety of use cases in augmented reality (AR).

At least one conventional approach to semantic image segmentation involves assigning semantic labels to an image at a pixel level. For the example of the image of the car parked in the street, each pixel in the image may be classified as one of a car, street, sidewalk, sky, grass, tree, building, or person; other classifications may be made. Some semantic image segmentation is performed using a machine learning (ML) inference model. Specifically, such an ML inference model may take the form of a convolutional neural network (CNN) classifier. Such a network may take in as input a grayscale or RGB image and output a map of semantic labels at each pixel of the image.

A technical problem with the above-described conventional approach is that, while pixel-level semantic image segmentation may be known for static images, it may be problematic over multiple image frames. For example, semantic labels generated from an ML inference model may take more than 100 ms for a single frame.

In accordance with the implementations described herein, a technical solution to the above-described technical problem includes storing semantic information in data structures that are updated at a rate less than a nominal frame rate. For example, a semantic model is applied to a first camera image frame in a sequence of frames to produce semantic data for each pixel in the frame. In addition, a first edge image is derived from the first camera image frame to define boundaries for the semantic labels. A first semantic image may be derived from the semantic data and the first edge image. The semantic data is then stored in the data structures. For a second camera image frame of the sequence, a second edge image is derived but the semantic data is exported from the data structures to the second edge image to produce a second semantic image without generating new semantic data.

In some implementations, the data structures are surface elements (surfels) derived from depth information taken from a camera image frame. For example, each of the surfels may be a point sample in a three-dimensional grid. Each surfel may include shape and/or shade attributes that locally approximate an object surface. In this case, the surfels provide position data in a world coordinate system as well as surface orientation information.

Accordingly, the technical solution involves storing semantic information taken from the first camera frame in surfels generated from the first camera frame. That is, semantic information for a subset of pixels that correspond to surfels is transferred from those pixels to the surfels.

Because the surfels have positions expressed in world coordinates, the position information of the surfels is preserved across camera frames and accordingly, the surfels do not need updating at each camera frame but rather after a set of frames, e.g., every 10-20 frames. Moreover, the semantic information stored in the surfels does not need to be updated with each camera frame but rather with after a set of frames, e.g., every 5-10 frames. To create a semantic image with semantic labels for each pixel, the semantic data in each surfel is exported to create a sparse semantic image, and then a densification operation is performed on the sparse semantic image to produce a dense semantic image. The dense semantic image may be generated at the full camera frame rate.

A technical advantage of the technical solution is that, in contrast to the conventional approach, the technical solution improves at least latency, accuracy, temporal stability, and so forth. The technical solution also provides flexibility in model output image resolution. More details about the technical solution are described below in connection with the figures.

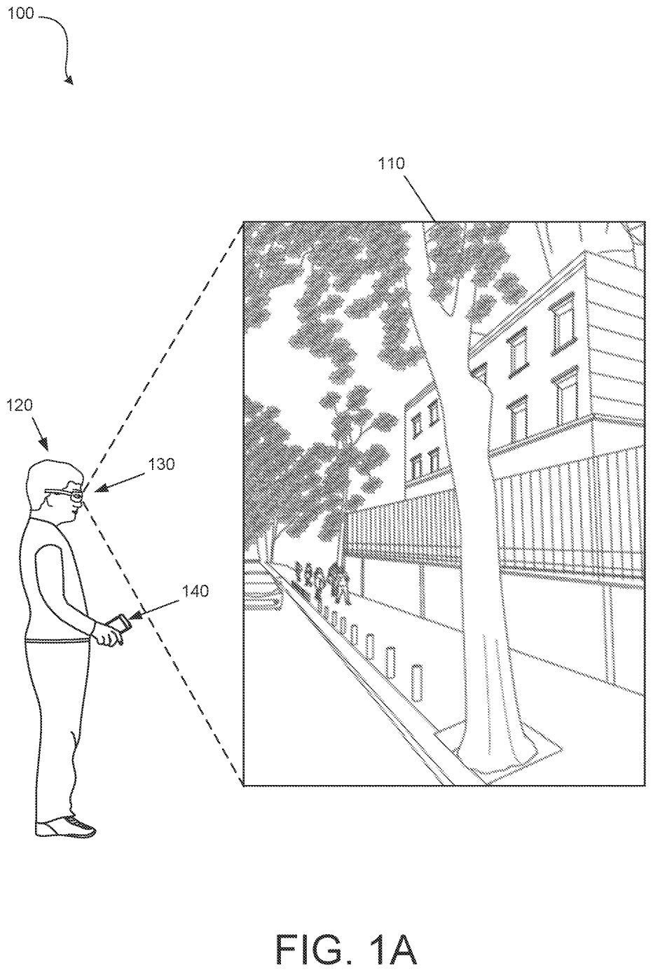

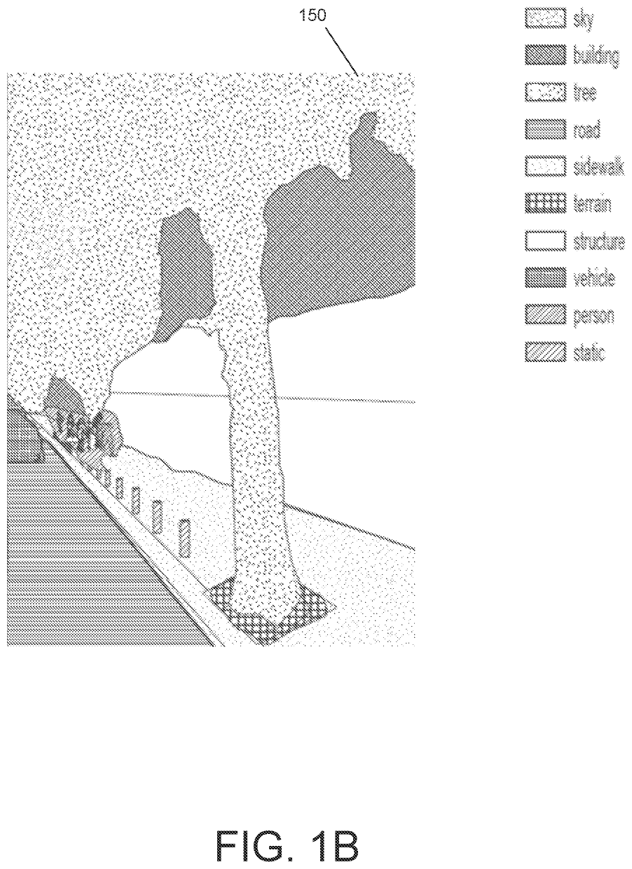

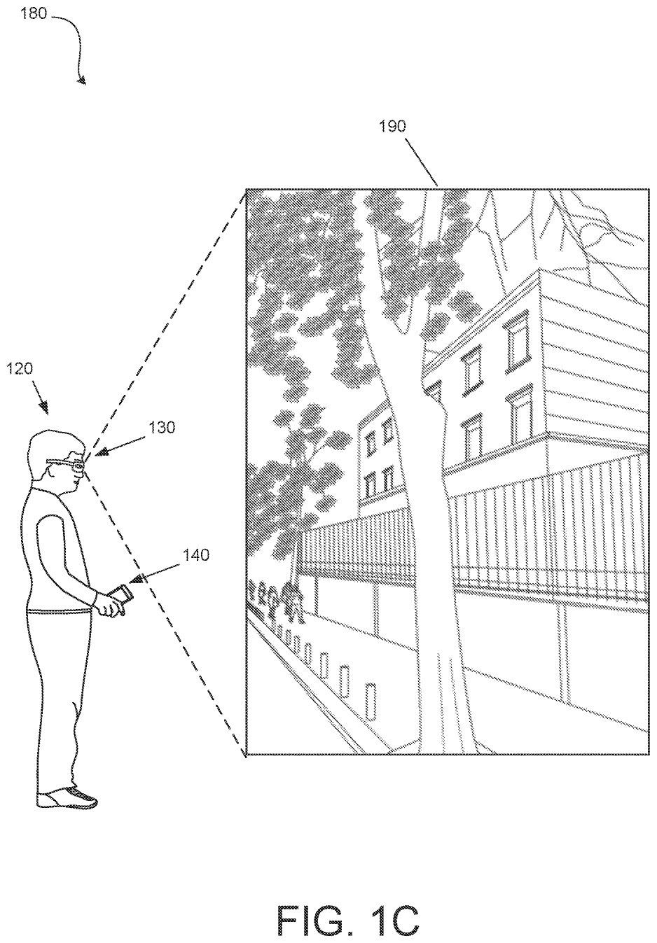

FIGS. 1A-1C illustrate camera image frames captured by a user and converted to a semantic image. As shown in FIGS. 1A and 1C, the user is using a smartglasses device to view the captured images on an augmented reality (AR) display. The semantic image in FIG. 1B can be used by an AR application to place virtual objects in appropriate locations in the images in FIGS. 1A and 1C as displayed in the AR display. The semantic image illustrated in FIG. 1B is derived from FIG. 1A. According to the implementations described herein, the semantic image shown in FIG. 1B is applied to FIG. 1C so that a separate and new semantic image does not need to be generated for FIG. 1C. This results in more efficient processing of semantic information and/or efficient placement of virtual objects in AR images by an AR application.

FIG. 1A illustrates a scenario 100 in which a representative camera image frame 110 of a sequence of frames (e.g., for a video) is captured by a user 120. As shown in FIG. 1A, the camera image frame 110 (which is of the real world) is captured using, for example, a world-facing camera of a smartglasses device 130 in an augmented reality (AR) application. In some implementations, the camera image frame 110 is captured using a mobile device 140 (e.g., a smartphone). In some implementations, processing of the image may be shared between the smartglasses device 30 and the mobile device 140. It is noted that, as shown in FIG. 1A, the camera image frame is an image of a three-dimensional scene (e.g., a vehicle parked in a road by a sidewalk having a tree planted in it, by a building behind a wall structure).

For example, the AR application may be a navigation application that provides navigational directions to the user. Such directions may appear in the form of an arrow in the road. To place an arrow in the road, the portion of the camera image frame 110 that is the road should be identified as such, as opposed to the portions that are in the tree or the building.

FIG. 1B illustrates an example semantic image of the three-dimensional scene in FIG. 1A. The semantic image 150 of the three-dimensional scene is a classification of each pixel of the camera image frame 110 into one of a predefined set of semantic classifications. As shown in FIG. 1B, the semantic classifications in semantic image 150 include “sky,” “building,” “tree,” “road,” “sidewalk,” “terrain,” “structure,” “vehicle,” “person,” and “static.” Each pixel of the semantic image is associated with one of the above-listed semantic classifications.

The semantic image segmentation resulting in semantic image 150 is performed for each pixel of the camera image frame 110 using a machine learning (ML) inference model (e.g., a convolutional neural network (CNN) classifier). Such a ML inference model can take more than 100 ms to run on a single image frame such as camera image frame 110. Accordingly, for a camera image frame sequence that has a frame rate of, say, 30 Hz, where each frame is current for about 33 ms, it would not be possible to generate a semantic image for every camera image frame when the semantic images are all generated per pixel using the ML inference model.

The above-described technical solution, then, stores the semantic classifications from the semantic image 150 into data structures that persist through several camera image frames. For example, if the semantic information in semantic image 150 were to be stored for five camera image frames at a frame rate of 30 Hz, that would represent an elapsed time of about 167 ms, which is greater than the time to generate a per-pixel semantic image (100 ms).

Accordingly, instead of generating per-pixel semantic images for every camera image frame of a sequence, a per-pixel semantic image such as semantic image 150 is generated for a first camera image frame of a sequence (e.g., camera image frame 110). The semantic classifications per pixel of the semantic image are then stored in data structures that persist over several camera image frames of the sequence. The semantic classifications are then used along with a subsequent camera image frame of the sequence to form a new semantic image.

FIG. 1C illustrates a scenario 180 in which a subsequent camera image frame 190 of the sequence of frames is captured by the user 120. For the camera image frame 190, a per-pixel semantic classification is not performed to create a semantic image. Rather, the stored semantic classifications from the semantic image 150 is used in concert with the camera image frame 190 to generate a semantic image for the camera image frame 190. In some implementations, an edge image (i.e., a map of the discontinuities, e.g., lines or curves along which there is a sudden change in the color, brightness, or any other characteristics of the pixels) of camera image frame 190 is generated and the semantic classifications from semantic image 150 are used to “fill in” the edge image to create a new semantic image. In some implementations, edge-guided filter operations are used to fill in the semantic information.

It is also noted that semantic labels near discontinuities in the camera image frame 100 may not be stable over time. For example, a pixel classified as “road” at a first time near an imaginary line dividing the road and the sidewalk in the semantic image 150 may be classified as “sidewalk” at a second time. At least one reason for this is that different image frames generate semantic labels independently, i.e., using a machine learning (ML) inference model. Such a model may be sensitive to small differences in the image frames and accordingly may provide different labels for the same pixel location at or near a discontinuity, thus introducing some instability in the semantic classification over time.

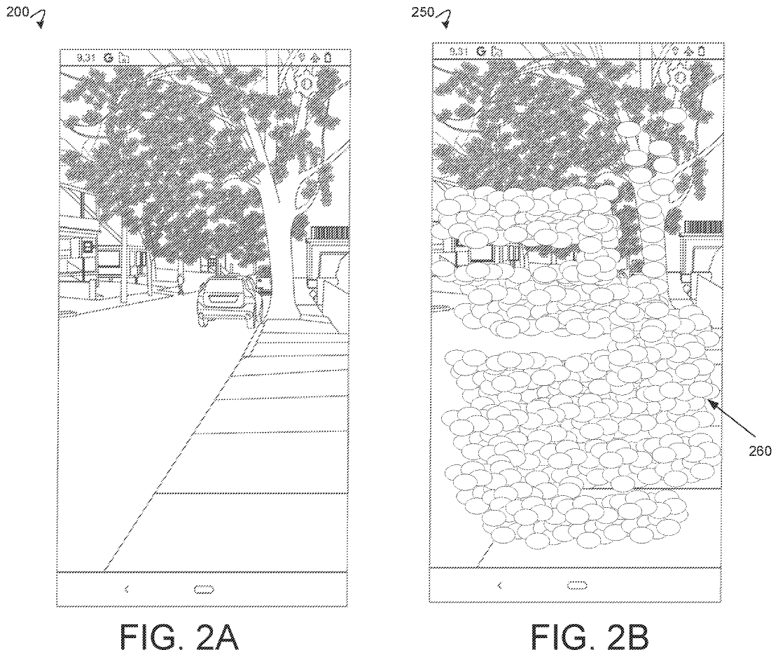

One way to generate semantic images at the camera frame rate and reduce temporal instability is to store the semantic classification in a data structure that persists over time. An example of such a data structure is described as follows, with regard to FIGS. 2A and 2B. Specifically, at least one data structure that can be used to store semantic classifications take the form of surface elements (surfels).

FIGS. 2A and 2B are, respectively, a representative camera image frame 200 and a corresponding image 250 with surface elements (surfels) 260. A pixel when projected into a representation of a surface can be considered a surfel 260. Surfels 260 can be used to efficiently render complex geometric objects in a 3D space in real-time (at interactive frame rates). A surfel 260 can be a point primitive that lacks any specific connectivity. As such, surfels 260 can be used to model dynamic geometry because topology information, such as adjacency information, does not need to be computed. Attributes of a surfel 260 can include, but are not limited to, depth, texture color, and a normalized vector and position. As disclosed herein, a surfel 260 can also include a semantic classification.

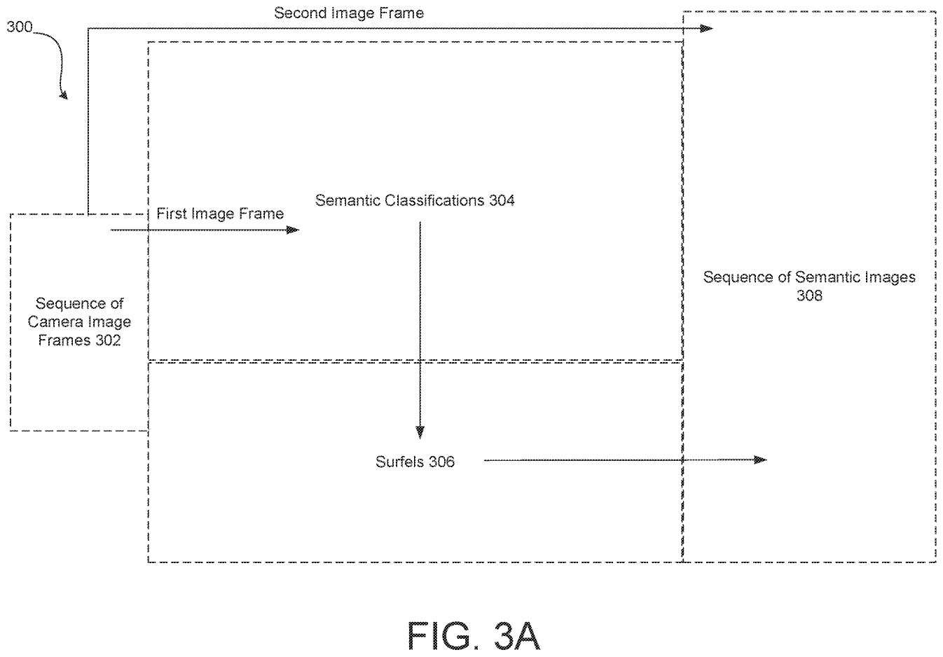

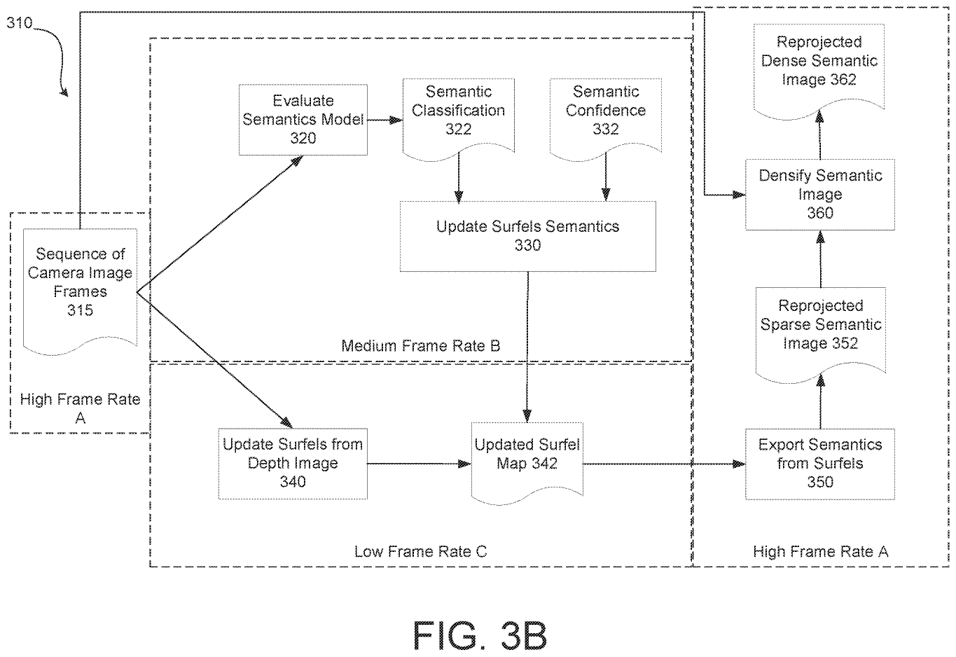

In an example implementation, surfels 260 can be generated from a depth image. The depth image may be in turn generated from the camera image frame 200 by first estimating the normal orientation associated with each pixel in the input. Once there is a depth value and normal vector associated with each pixel, surfels 260 can be generated by clustering these pixels and generating disks represented in world coordinates. The size of these disks can be based on a number of neighboring pixels that share the same depth, orientation, and semantic label. As discussed previously and as will be discussed with regard to FIG. 3, these surfels 260 can be stored across frames of a sequence of frames, and as new semantic classifications are integrated, the semantic classification of the surfels 260 can be updated based on this new information.

In some implementations, surfels 260 also include confidence information with regard to the semantic classification. If new semantic information disagrees with the previous surfel data, the original surfels can be penalized with decreased confidence. If the new semantic information agrees with the previous surfel data, the original surfels can be rewarded with increased confidence. In some implementations, a surfel with sufficiently low confidence may disappear, while a surfel with sufficiently high confidence will persist. In some implementations, a surfel may store more than one semantic classification, each with its own confidence value. The semantic classifications stored in the surfels may be used to generate new semantic images for subsequent frames of a sequence of frames. It is noted, however, that subsequent frames can have a (slightly) different field of view as the original frame from which a per-pixel semantic image was generated. Accordingly, the surfels are expressed in world coordinates rather than the coordinates of the frame from which their depth image was derived.

FIG. 3A is a flow chart illustrating a high-level process 300 of generating a sequence of semantic images 308 from a sequence of camera image frames 302 at the same frame rate. In some implementations, the process 300 is performed by one or more processors (e.g., processing circuitry) in a mobile device (e.g., smartphone, tablet computer). In some implementations, the process 300 is performed by one or more processors in a wearable electronic device (e.g., smartglasses, goggles). In some implementations, the process 300 is shared between one or more processors of a mobile device and a paired wearable electronic device.

From a first image frame of the sequence of camera image frames 302 (e.g., camera image frame 110 of FIG. 1A), the one or more processors derive per-pixel semantic classifications 304. These per-pixel semantic classifications may be used to form a semantic image for the first image frame as part of the sequence of semantic images 308 (e.g., semantic image 150 in FIG. 1B). Moreover, the per-pixel semantic classifications are stored in surfels 306.

The one or more processors create a new semantic image of the sequence of semantic images 308 from the semantic classifications stored in the surfels 306 and a second, subsequent image frame (e.g., camera image frame 190 in FIG. 1C). Such semantic classifications are used in AR applications such as navigation applications, in which a user follows an arrow in the road.

For example, as discussed with regard to FIG. 3B below, an edge image of the second image frame is computed and the semantic classifications from the surfels 306 are used to fill in the image discontinuities and hence create the semantic image.

It is noted that the surfels 306 may also be updated at yet another camera image frame. This is also discussed with regard to FIG. 3B.

FIG. 3B is a flow chart illustrating a process 310 of generating semantic images at a full framerate using surfel reprojection of the semantic data. In some implementations, the process 310 is performed by one or more processors (e.g., processing circuitry) in a mobile device (e.g., smartphone, tablet computer). In some implementations, the process 310 is performed by one or more processors in a wearable electronic device (e.g., smartglasses, goggles). In some implementations, the process 310 is shared between one or more processors of a mobile device and a paired wearable electronic device.

The one or more processors initially receives a sequence of camera image frames 315 as in FIGS. 1A and 1C. The sequence of camera image frames 310 is generated at a high frame rate A as shown in FIG. 3B. In some implementations, the high frame rate A is greater than 10 Hz. In some implementations, the high frame rate A is 30 Hz. Each camera image frame has a specified number of pixels, e.g., 600×400, 1024×768, 1920×1080 and represents a scene with three-dimensional geometry. In some implementations, the sequence of image frames is captured using a camera on a mobile device. In some implementations, the sequence of image frames is captured using a camera on a wearable electronic device, e.g., a world facing camera on a smartglasses device.

The one or more processors then, at 320, evaluate a semantics model on a camera image frame of the sequence 315 to produce a semantic classification 322 of each pixel in the camera image frame. The semantics model takes as input a camera image frame and outputs per-pixel semantic classifications 322. It is noted that the per-pixel semantic classifications 322 may be used to form a semantic image for the camera image frame from which the per-pixel semantic classification 322 was derived, as is the case for the per-pixel semantic image shown in FIG. 1B. In some implementations, the semantics model is a machine learning inference model. In some implementations, the semantics model is a convolutional neural network. In some implementations, the semantics model is an encoder-decoder network employing atrous convolution in the encoder.

As shown in FIG. 3B, the evaluation 320 of the semantics model is performed at a rate smaller than the camera frame rate: medium frame rate B. In some implementations, medium frame rate B is a fraction of the camera frame rate, e.g., ½, ⅓, ¼, ⅕, ⅙, etc. For example, if high frame rate A is 30 Hz, then medium frame rate B can be 15 Hz, 10 Hz, 7.5 Hz, 6 Hz, 5 Hz, etc. As discussed previously, the semantics model is evaluated at a rate B lower than the camera frame rate A because the per-pixel ML inference model is a resource-intensive computation that occupies more than a single frame duration.

In some implementations, the evaluation 320 of the semantics model is performed based on user movement. That is, in such implementations, when a user of the processing circuitry is not moving the mobile/wearable device, the processing circuitry does not perform new evaluations of the semantics model.

The one or more processors, at 330, use the semantic classification to update at 330 the semantic classifications of an existing set of surfels representing the sequence of camera image frames 315. Because the updating 330 of the semantic classifications of the surfels takes place upon the evaluation 320 of the semantics model, the updating 330 of the semantic classifications of the surfels occurs at the same rate (medium frame rate B as shown in FIG. 3B) as the evaluation 320 of the semantics model.

Because the semantic classification 322 is updated 330 within the same surfel, in some implementations a semantic confidence 332 is also updated. The semantic confidence (or, confidence) indicates a likelihood that the semantic classification stored in the surfel is correct. For example, if the sematic classification 322 of a surfel remains the same after updating, the semantic confidence 332 is increased (e.g., by 50%, by 20%, by 10%, by 5%, by 1%). If the semantic classification 322 of a surfel changes after the updating, the semantic confidence 332 is decreased (e.g., by 50%, by 20%, by 10%, by 5%, by 1%). In some implementations, each surfel has more than one semantic classification, each with its own respective confidence that increases or decreases according to whether that semantic classification agrees with the updated semantic classification 322. The semantic classification with the highest confidence will be exported to the semantic image.

The one or more processors, at 340, generate from a camera image frame of the sequence 315 a depth image, and from the depth image the processing circuitry produces an updated surfel map 342. The updated surfel map 342 is a set of surfels that represent the camera image frame from which the depth image was generated. In the example shown in FIG. 3B, the depth image and resulting surfel map 342 is generated at a low frame rate C that is lower than both the high frame rate A and the medium frame rate B. In some implementations, the low frame rate C can be 1/10, 1/15, 1/20, etc. of the high frame rate A. For example, when the high frame rate A is 30 Hz and the medium frame rate B is 5 Hz, the low frame rate C can be 1-3 Hz, e.g., 2 Hz.

In some implementations, the updated surfel map 342 includes updated surfels semantics 330 from the previous surfels. Nevertheless, at some current camera image frame, the per-pixel semantics model is updated at 320; the pixels are matched with the new surfel map 342 and align to those surfels within the field of view of the current camera image frame. In addition, the semantic confidence values transfer to the updated surfel map 342, likewise.

It is noted that the updated surfel map 342 is cumulative. That is, the updated surfel map 342 includes older surfels that may be outside of the field of view of the current camera image frame. The older surfels in the field of view of the current camera image frame will have their semantic classification and confidence updated. The older surfels outside of the field of view of the current camera image frame may maintain their semantic classification and confidence. The updated surfel map 342 being cumulative is enabled by the surfels having positions in world coordinates so they are not tied to any particular camera image frame coordinates.

The one or more processors meanwhile are generating semantic images from the surfel information at a rate of the camera image frame rate. As shown in FIG. 3B, the one or more processors generate semantic images at the high frame rate A, the camera image frame rate. The semantic images as described herein may be generated at any rate up to the camera image frame rate.

To this effect, the one or more processors at 350 export semantic classifications from the surfels to produce a reprojected sparse semantic image 352. The reprojected sparse semantic image 352 is a representation of the semantic classification over the surfel locations in world coordinates. Because the surfels may be sparse compared to, e.g., pixels in a camera image frame, the coverage of semantic information over the world coordinates is also sparse.

The one or more processors, at 360, input the reprojected sparse semantic image 352 into a densification process to densify the reprojected sparse semantic image 352 into a reprojected dense semantic image at 360 based on a current camera image frame of the sequence 315. That is, as shown in FIG. 3, for every camera image frame in the sequence 315, there is a corresponding reprojected sparse semantic image that is converted into a reprojected dense semantic image 362.

The one or more processors, at 360, densify the reprojected sparse semantic image 352 using an infill solver such as a bilateral solver to perform an infill operation on the reprojected sparse semantic image 352. Other infill solvers include image floodfilling, gradient solvers, and the like. The one or more processors restrict the surfels represented in the reprojected sparse semantic image 352 to those in the field of view of the current image frame. The one or more processors generate an edge image of the current image frame of the sequence 315 that represents discontinuities in the current image frame. The infill solver fills in semantic information from the reprojected sparse semantic image 352 within the discontinuities in the current image frame to produce the reprojected dense semantic image 362, i.e., the current semantic image.

In summary, the one or more processors can generate a semantic image for every camera image frame at the camera image frame rate without evaluating a semantics model at every frame by storing the semantic classifications in surfels and letting that information persist over several camera image frames. The semantic images are generated at the frame rate by exporting the semantic classifications into a sparse image and using an edge image of a current camera image frame in a bilateral solver to perform densification of the semantic classifications.

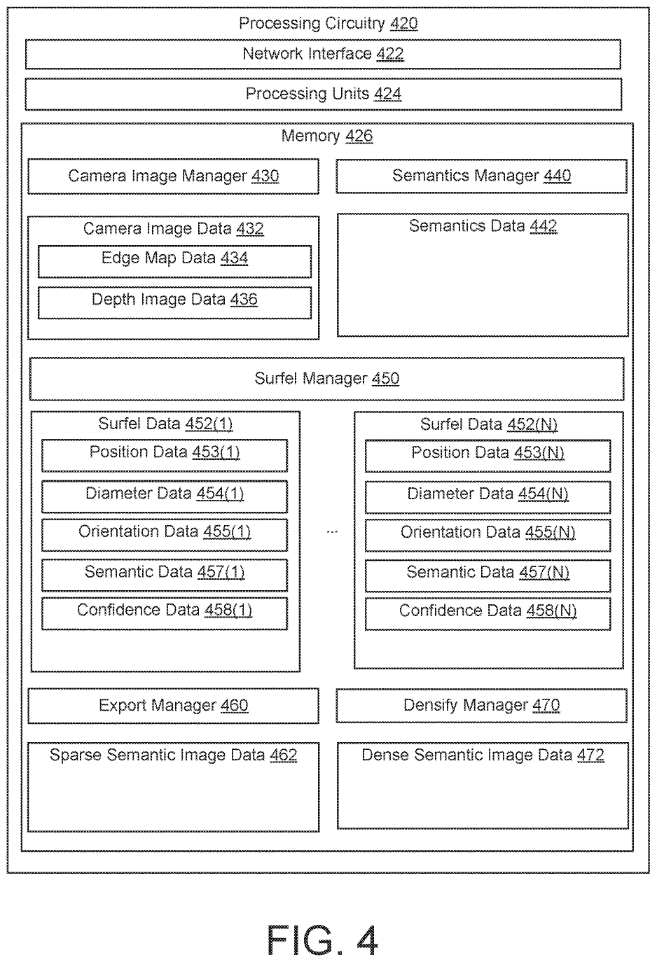

FIG. 4 is a diagram that illustrates an example processing circuitry 420. The processing circuitry 420 is configured to generate a semantic image for every camera image frame at the camera image frame rate without evaluating a semantics model at every frame by storing the semantic classifications in surfels and letting that information persist over several camera image frames. In some implementations, the processing circuitry 420 can be embedded in a mobile device such as a smartphone. In some implementations, the processing circuitry 420 can be embedded in a wearable electronic device such as a smartglasses device.

The processing circuitry 420 includes a network interface 422, one or more processing units 424, and nontransitory memory 426. The network interface 422 includes, for example, Ethernet adaptors, Bluetooth adaptors, and the like, for converting electronic and/or optical signals received from the network to electronic form for use by the processing circuitry 420. The set of processing units 424 include one or more processing chips and/or assemblies.

The memory 426 includes both volatile memory (e.g., RAM) and non-volatile memory, such as one or more read only memories (ROMs), disk drives, solid state drives, and the like. The set of processing units 424 and the memory 426 together form controlling circuitry, which is configured and arranged to carry out various methods and functions as described herein.

In some implementations, one or more of the components of the processing circuitry 420 can be, or can include processors (e.g., processing units 424) configured to process instructions stored in the memory 426. Examples of such instructions as depicted in FIG. 4 include a camera image manager 430, a semantics manager 440, a surfel manager 450, an export manager 460, and a densify manager 470. Further, as illustrated in FIG. 4, the memory 426 is configured to store various data, which is described with respect to the respective managers that use such data.

The camera image manager 430 is configured to receive camera image data in the form of a sequence of camera image frames. The camera image manager 430 is configured to display the sequence of camera image frames on a display (e.g., a display of a mobile device or a wearable electronic device) at a specified frame rate (e.g., 30 Hz).

In some implementations, the camera image data 432 includes the sequence of camera image frames (e.g., sequence 310 of FIG. 3). The camera image manager 430 may be configured to add images to the sequence as long as a user operating the device (e.g., mobile device, wearable electronic device) is recording a scene. Each camera image frame in the sequence has a specified number of pixels (e.g., 800×600).

The camera image manager 430 is also configured to generate edge map data 434 representing an edge image of a camera image frame, e.g., discontinuities in the camera frame image. In some implementations, the edge image is obtained from the camera image data 432 using a derivative computation.

The camera image manager 430 is also configured to generate depth image data 436 representing a depth image of a camera image frame, e.g., providing a depth value for each pixel in a camera image frame. In some implementations, the depth image is obtained from the camera image data 432 using, e.g., a depth machine learning model.

The semantics manager 440 is configured to generate semantics data 442, e.g., a semantic classification at each pixel of a camera image frame (e.g., a frame of camera image data 432) using a semantics model. The semantics model takes as input a camera image frame and outputs per-pixel semantic classifications as semantics data 442. In some implementations, the semantics model is a machine learning inference model. In some implementations, the semantics model is a convolutional neural network. In some implementations, the semantics model is an encoder-decoder network employing atrous convolution in the encoder.

The surfel manager 450 is configured to generate surfel data 452(1 . . . N), a surfel representation of the camera image data 432. The surfel data 452(1 . . . N) persists in the memory 426 over several camera image frames. The surfel manager 450 generates the surfel data 452(1 . . . N) using camera image data 432 and especially depth image data 436. Each of the surfel data 452(1 . . . N), e.g., 452(1) as shown in FIG. 4 has the following attributes.

Position data 453(1) is the position of a center of surfel 452(1) in world coordinates, e.g., a fixed coordinate system independent of any camera coordinate system. A world coordinate system is used because the surfels as represented by surfel data 452(1 . . . N) are cumulative; that is, a surfel is stored in memory 426 even when the current image frame has a field of view outside of its position.

Diameter data 454(1) is the size of a diameter of surfel 452(1), e.g., a largest distance across two points on a surfel edge. The diameter of surfel 452(1) may not be the same as the diameter of surfel 452(2), surfel 452(3), . . . , 452(N). The diameter of a surfel may be determined from local depth conditions. For example, two surfels having the same depth, orientation, and semantic classification may merge into a single, larger surfel.

Orientation data 455(1) is the direction of a normal at the center of surfel 452(1). The direction of the normal may be determined from local conditions in the depth image data 436(1).

Semantic data 457(1) is the semantic classification associated with surfel 452(1). Surfel manager 450 is configured to store and/or update at least one semantic classification in surfel 452(1). In some implementations, the semantic data 457(1) is taken from the semantic classification of pixels in semantics data 442. In some implementations, the semantic data 457(1) is taken from those pixels having a position within surfel 452(1), e.g., position data 453(1)+/−0.5*diameter data 454(1) in any direction.

Confidence data 458(1) is the semantic confidence of the semantic classification in semantic data 457(1). The semantic confidence (or, confidence) indicates a likelihood that the semantic classification stored in the surfel is correct. For example, if after an update of semantic classifications of surfels a semantic classification in semantic data 457(1) is unchanged, the semantic confidence may increase, e.g., go from 50% to 75%. If after such an update the semantic classification in semantic data 457(1) changes, the semantic confidence may decrease, e.g., go from 50% to 25%.

In some implementations, semantic data 457(1) includes more than one semantic classification, each with its own associated confidence in confidence data 458(1). When exporting the semantic classification in such an implementation, the export manager 460 chooses the semantic classification with the highest confidence.

The export manager 460 is configured to generate sparse semantic image data 462 representing a reprojected sparse semantic image (e.g., sparse semantic image). That is, the export manager exports the semantic classifications in semantic data 457(1 . . . N) to their world coordinate positions 453(1 . . . N) in a sparse image. The image is sparse because the surfel representation may be sparse. The export manager 460 performs the export at the camera image frame rate.

The densification manager 470 is configured to generate dense semantic image data 472 (e.g., the output semantic image) from the sparse semantic image data 462 and edge map data 434. The densification manager 470 performs this task by, e.g., an infill operation using a bilateral solver as described above. To accomplish this, the densification manager 470 restricts the surfels represented in the sparse semantic image data 462 to those having positions the field of view of the current image frame. The densification manager 470 also performs this densification at the camera image frame rate.

The components (e.g., modules, processing units 424) of processing circuitry 420 can be configured to operate based on one or more platforms (e.g., one or more similar or different platforms) that can include one or more types of hardware, software, firmware, operating systems, runtime libraries, and/or so forth. In some implementations, the components of the processing circuitry 420 can be configured to operate within a cluster of devices (e.g., a server farm). In such an implementation, the functionality and processing of the components of the processing circuitry 420 can be distributed to several devices of the cluster of devices.

The components of the processing circuitry 420 can be, or can include, any type of hardware and/or software configured to correct misalignment of smartglasses displays. In some implementations, one or more portions of the components shown in the components of the processing circuitry 420 in FIG. 4 can be, or can include, a hardware-based module (e.g., a digital signal processor (DSP), a field programmable gate array (FPGA), a memory), a firmware module, and/or a software-based module (e.g., a module of computer code, a set of computer-readable instructions that can be executed at a computer). For example, in some implementations, one or more portions of the components of the processing circuitry 420 can be, or can include, a software module configured for execution by at least one processor (not shown). In some implementations, the functionality of the components can be included in different modules and/or different components than those shown in FIG. 4, including combining functionality illustrated as two components into a single component.

Although not shown, in some implementations, the components of the processing circuitry 420 (or portions thereof) can be configured to operate within, for example, a data center (e.g., a cloud computing environment), a computer system, one or more server/host devices, and/or so forth. In some implementations, the components of the processing circuitry 420 (or portions thereof) can be configured to operate within a network. Thus, the components of the processing circuitry 420 (or portions thereof) can be configured to function within various types of network environments that can include one or more devices and/or one or more server devices. For example, the network can be, or can include, a local area network (LAN), a wide area network (WAN), and/or so forth. The network can be, or can include, a wireless network and/or wireless network implemented using, for example, gateway devices, bridges, switches, and/or so forth. The network can include one or more segments and/or can have portions based on various protocols such as Internet Protocol (IP) and/or a proprietary protocol. The network can include at least a portion of the Internet.

In some implementations, one or more of the components of the search system can be, or can include, processors configured to process instructions stored in a memory. For example, camera image manager 430 (and/or a portion thereof), semantics manager 440 (and/or a portion thereof), surfel manager 450 (and/or a portion thereof), export manager 460 (and/or a portion thereof), and densification manager 470 (and/or a portion thereof) are examples of such instructions.

In some implementations, the memory 426 can be any type of memory such as a random-access memory, a disk drive memory, flash memory, and/or so forth. In some implementations, the memory 426 can be implemented as more than one memory component (e.g., more than one RAM component or disk drive memory) associated with the components of the processing circuitry 420. In some implementations, the memory 426 can be a database memory. In some implementations, the memory 426 can be, or can include, a non-local memory. For example, the memory 426 can be, or can include, a memory shared by multiple devices (not shown). In some implementations, the memory 426 can be associated with a server device (not shown) within a network and configured to serve the components of the processing circuitry 420. As illustrated in FIG. 4, the memory 426 is configured to store various data, including camera image data 432, semantics data 442, and surfel data 452(1 . . . N).

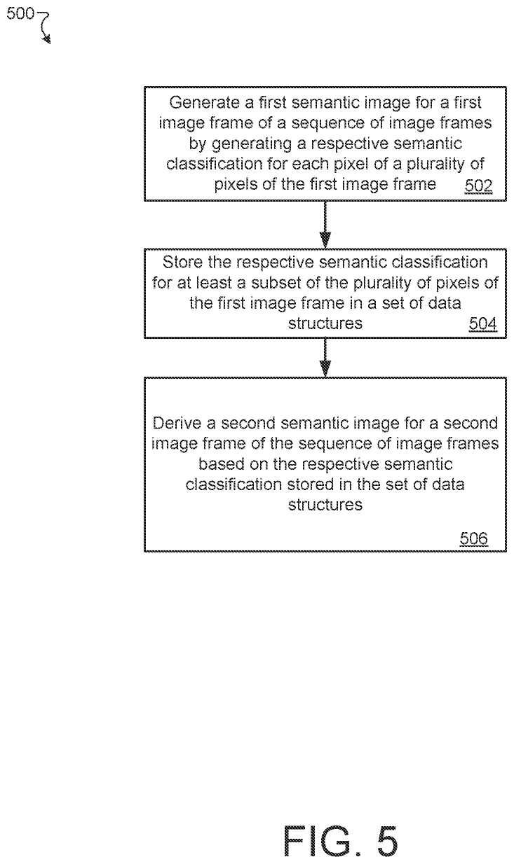

FIG. 5 is a flow chart illustrating a method 500 of generating semantic images at a camera image frame rate.

At 502, a semantics manager (e.g., semantics manager 440) generates a first semantic image for a first image frame of a sequence of image frames by generating a respective semantic classification for each pixel of a plurality of pixels of the first image frame. The sequence of image frames is received by a camera image manager (e.g., camera image manager 430).

At 504, a data structure manager (e.g., surfel manager 450) stores the respective semantic classification for at least a subset of the plurality of pixels of the first image frame in a set of data structures. In some implementations, the data structures are surfels, in which the semantic classification is stored persistently across multiple image frames of the sequence of image frames.

At 506, an export manager (e.g., export manager 460) and a densification manager (e.g., densification manager 470) derive a second semantic image for a second image frame of the sequence of image framesbased on the respective semantic classification stored in the set of data structures. This is possible due to the persistence of semantic classification information stored in the data structures (e.g., surfels) over multiple image frames.

Specific structural and functional details disclosed herein are merely representative for purposes of describing example embodiments. Example embodiments, however, may be embodied in many alternate forms and should not be construed as limited to only the embodiments set forth herein.

The terminology used herein is for the purpose of describing particular embodiments only and is not intended to be limiting of the embodiments. As used herein, the singular forms “a,” “an,” and “the” are intended to include the plural forms as well, unless the context clearly indicates otherwise. It will be further understood that the terms “comprises,” “comprising,” “includes,” and/or “including,” when used in this specification, specify the presence of the stated features, steps, operations, elements, and/or components, but do not preclude the presence or addition of one or more other features, steps, operations, elements, components, and/or groups thereof.

It will be understood that when an element is referred to as being “coupled,” “connected,” or “responsive” to, or “on,” another element, it can be directly coupled, connected, or responsive to, or on, the other element, or intervening elements may also be present. In contrast, when an element is referred to as being “directly coupled,” “directly connected,” or “directly responsive” to, or “directly on,” another element, there are no intervening elements present. As used herein the term “and/or” includes any and all combinations of one or more of the associated listed items.

Spatially relative terms, such as “beneath,” “below,” “lower,” “above,” “upper,” and the like, may be used herein for ease of description to describe one element or feature in relationship to another element(s) or feature(s) as illustrated in the figures. It will be understood that the spatially relative terms are intended to encompass different orientations of the device in use or operation in addition to the orientation depicted in the figures. For example, if the device in the figures is turned over, elements described as “below” or “beneath” other elements or features would then be oriented “above” the other elements or features. Thus, the term “below” can encompass both an orientation of above and below. The device may be otherwise oriented (rotated 70 degrees or at other orientations) and the spatially relative descriptors used herein may be interpreted accordingly.

Example embodiments of the concepts are described herein with reference to cross-sectional illustrations that are schematic illustrations of idealized embodiments (and intermediate structures) of example embodiments. As such, variations from the shapes of the illustrations as a result, for example, of manufacturing techniques and/or tolerances, are to be expected. Thus, example embodiments of the described concepts should not be construed as limited to the particular shapes of regions illustrated herein but are to include deviations in shapes that result, for example, from manufacturing. Accordingly, the regions illustrated in the figures are schematic in nature and their shapes are not intended to illustrate the actual shape of a region of a device and are not intended to limit the scope of example embodiments.

It will be understood that although the terms “first,” “second,” etc. may be used herein to describe various elements, these elements should not be limited by these terms. These terms are only used to distinguish one element from another. Thus, a “first” element could be termed a “second” element without departing from the teachings of the present embodiments.

Unless otherwise defined, the terms (including technical and scientific terms) used herein have the same meaning as commonly understood by one of ordinary skill in the art to which these concepts belong. It will be further understood that terms, such as those defined in commonly used dictionaries, should be interpreted as having a meaning that is consistent with their meaning in the context of the relevant art and/or the present specification and will not be interpreted in an idealized or overly formal sense unless expressly so defined herein.

While certain features of the described implementations have been illustrated as described herein, many modifications, substitutions, changes, and equivalents will now occur to those skilled in the art. It is, therefore, to be understood that the appended claims are intended to cover such modifications and changes as fall within the scope of the implementations. It should be understood that they have been presented by way of example only, not limitation, and various changes in form and details may be made. Any portion of the apparatus and/or methods described herein may be combined in any combination, except mutually exclusive combinations. The implementations described herein can include various combinations and/or sub-combinations of the functions, components, and/or features of the different implementations described.

1. A method, comprising:
generating, by at least one processor, a first semantic image for a first image frame of a sequence of image frames by generating a respective semantic classification for each pixel of a plurality of pixels of the first image frame;
storing, by the at least one processor, the respective semantic classification for at least a subset of the plurality of pixels of the first image frame in a set of data structures; and
deriving, by the at least one processor, a second semantic image for a second image frame of the sequence of image frames based on the respective semantic classification stored in the set of data structures.

2. The method as in claim 1, further comprising:
generating, by the at least one processor, a respective semantic classification for each pixel of a plurality of pixels of a third image frame of the sequence of image frames, the third image frame coming after the second image frame, the second image frame coming after the first image frame; and
updating, by the at least one processor, the respective semantic classification for at least a subset of the plurality of pixels of the third image frame in the set of data structures.

3. The method as in claim 2, wherein the set of data structures includes a set of surface elements (surfels), each of the set of surfels including depth information from a first depth image of the first image frame and a semantic classification;
wherein updating of the semantic classification for at least the subset of the plurality of pixels of the third image frame in the set of data structures includes:
updating the semantic classification of at least a surfel associated with the subset of the plurality of pixels of the third image frame.

4. The method as in claim 3, wherein each of the set of surfels further includes a respective confidence indicating a likelihood that the semantic classification stored in each surfel is correct.

5. The method as in claim 4, further comprising:
in response to a semantic classification of a first surfel of the set of surfels being unchanged after the updating, increasing, by the at least one processor, the confidence of the first surfel; and/or
in response to a semantic classification of the first surfel being changed after the updating, decreasing, by the at least one processor, the confidence of the first surfel.

6. The method as claim 3, wherein deriving the second semantic image for the second image frame includes:
restricting the set of surfels to those surfels of the set of surfels having positions that are within a field of view of the second image frame.

7. The method as in claim 3, wherein deriving the second semantic image for the second image frame includes:
exporting the semantic classification stored in each surfel of the set of surfels to a sparse semantic image;
generating an edge map representing discontinuities in the second image frame; and
generating the second semantic image by performing a densification operation on the sparse semantic image, the densification operation aligning the semantic classification stored in each surfel of the set of surfels with the discontinuities in the second image frame.

8. The method as in claim 2, further comprising:
deriving the set of data structures from the first image frame, the set of data structures being a first set of data structures; and
deriving, by the at least one processor, a second set of data structures from a fourth image frame of the sequence of image frames, the fourth image frame coming after the third image frame in the sequence.

9. The method as in claim 1, wherein generating the first semantic image includes:
deriving a first edge image from the first image frame to define boundaries for the respective semantic classification for each pixel; and
wherein deriving the second semantic image includes:
deriving a second edge image from the second image frame; and
exporting the respective semantic classification stored in the set of data structures to the second edge image.

10. A computer program product comprising a nontransitory storage medium, the computer program product including code that, when executed by at least one processor, causes the at least one processor to perform a method, the method comprising:
generating a first semantic image for a first image frame of a sequence of image frames by generating a respective semantic classification for each pixel of a plurality of pixels of the first image frame;
storing the respective semantic classification for at least a subset of the plurality of pixels of the first image frame in a set of data structures; and
deriving a second semantic image for a second image frame of the sequence of image frames based on the respective semantic classification stored in the set of data structures.

11. The computer program product as in claim 10, further comprising:
generating a respective semantic classification for each pixel of a plurality of pixels of a third image frame of the sequence of image frames, the third image frame coming after the second image frame, the second image frame coming after the first image frame; and
updating the respective semantic classification for at least a subset of the plurality of pixels of the third image frame in the set of data structures.

12. The computer program product as in claim 11, wherein the set of data structures includes a set of surface elements (surfels), each of the set of surfels including depth information from a first depth image of the first image frame and a semantic classification;
wherein updating the semantic classification for at least the subset of the plurality of pixels of the third image frame in the set of data structures includes:
updating the semantic classification of at least a surfel associated with the subset of the plurality of pixels of the third image frame.

13. The computer program product as in claim 12, wherein each of the set of surfels further includes a respective confidence indicating a likelihood that the semantic classification stored in each surfel is correct.

14. The computer program product as in claim 13, further comprising:
in response to a semantic classification of a first surfel of the set of surfels being unchanged after the updating, increasing the confidence of the first surfel; and/or
in response to a semantic classification of the first surfel being changed after the updating, decreasing the confidence of the first surfel.

15. The computer program product as in claim 12, wherein deriving the second semantic image for the second image frame includes:
restricting the set of surfels to those surfels of the set of surfels that are within a field of view of the second image frame.

16. The computer program product as in claim 12, wherein deriving the second semantic image for the second image frame includes:
exporting the semantic classification stored in each surfel of the set of surfels to a sparse semantic image;
generating an edge map representing discontinuities in the second image frame; and
generating the second semantic image by performing a densification operation on the sparse semantic image, the densification operation aligning the semantic classification stored in each surfel of the set of surfels with the discontinuities in the second image frame.

17. The computer program product as in claim 11, further comprising:
deriving the set of data structures from the first image frame, the set of data structures being a first set of data structures; and
deriving a second set of data structures from a fourth image frame of the sequence of image frames, the fourth image frame coming after the third image frame in the sequence.

18. An apparatus, comprising:
memory; and
processing circuitry coupled to the memory, the processing circuitry being configured to:
generate a first semantic image for a first image frame of a sequence of image frames by generating a respective semantic classification for each pixel of a plurality of pixels of the first image frame;
store the respective semantic classification for at least a subset of the plurality of pixels of the first image frame in a set of data structures; and
derive a second semantic image for a second image frame of the sequence of image frames based on the respective semantic classification stored in the set of data structures.

19. The apparatus as in claim 18, wherein the processing circuitry is further configured to:
generate a respective semantic classification for each pixel of a plurality of pixels of a third image frame of the sequence of image frames, the third image frame coming after the second image frame, the second image frame coming after the first image frame; and
update the respective semantic classification for at least a subset of the plurality of pixels of the third image frame in the set of data structures.

20. The apparatus as in claim 19, wherein the set of data structures includes a set of surface elements (surfels), each of the set of surfels including depth information from a first depth image of the first image frame and a semantic classification;
wherein the processing circuitry configured to update the semantic classification for at least the subset of the plurality of pixels of the third image frame in the set of data structures is further configured to:
update the semantic classification of at least a surfel associated with the subset of the plurality of pixels of the third image frame.

21. The apparatus as in claim 20, wherein each of the set of surfels further includes a respective confidence indicating a likelihood that the semantic classification stored in each surfel is correct.
